(19) United States
(12) Patent Application Publication
(10) Pub. No.: US 2011/0229399 A1
(43) Pub. Date: Sep. 22, 2011

(54) Method for the production of polycrystalline silicon

(75) Inventors: Silvio Tozzoli, Kornwestheim (DE); Anatoli Vasilievich Pushko, Minsk (BY)

(73) Assignee: Sunlit S.r.l.

(21) Appl. No.: 12/998,409

(22) PCT Filed: Oct. 20, 2009
(86) PCT No.: PCT/IB2009/007166

§ 371 Date: Jun. 8, 2011

(30) Foreign Application Priority Data
Oct. 20, 2008 (IT) BO2008A000646

(51) Int. Cl. C01B 33/039; F27B 15/14

(52) U.S. Cl. 423/349; 422/146

(57) ABSTRACT

The process for the production of polycrystalline silicon starting from metallurgical silicon, milled up to a predetermined granulometry, implies the reaction of metallurgical silicon with anhydrous hydrogen fluoride (HF), to obtain silicon tetrafluoride (SiF₄), and to operate the synthesis of monosilane (SiH₄) by a reaction of hydrogenation of the silicon tetrafluoride (SiF₄) with alkaline or alkaline earth metals halide in fluid medium of organic solvent or melt salts. Then a thermal decomposition of said monosilane (SiH₄) in a boiling-pseudo fluidized bed reactor is carried out, to obtain high purity granulated polycrystalline silicon.

### TECHNICAL FIELD

The present invention concerns a process and an implant for the manufacturing of polycrystalline silicon utilizing metallurgical silicon as starting material. In particular, the invention relates to a technological process of polycrystalline silicon manufacture with high degree of purity permitting its use in photovoltaic solar panels production.

### STATE OF THE ART

By now, several technological processes for manufacturing polycrystalline silicon are known.

A first category of processes requires hydrogen reduction of trichlorosilane SiHCl₃ in a Siemens core-type reactor. For example, such process is described in the patents DE2447691, DE1148217, JP2005336045, JP2005008430, RU2224715C1, RU2136950, U.S. Pat. No. 4,525,334. Alternatively, such processes require growing granulated silicon in a boiling-bed reactor with hydrogen reduction of trichlorosilane, as disclosed in the patents CA1218218 and U.S. Pat. No. 5,798,137.

A second category of processes, illustrated for example in the patents DE102005044328A1, U.S. Pat. No. 6,395,248, U.S. Pat. No. 6,623,801B2, U.S. Pat. No. 5,382,419, requires thermal decomposition of monosilane in a Siemens core-type reactor, and further growing granulated polycrystalline silicon on the seeds surface in a boiling-bed reactor as disclosed in the patents JP2000178028, U.S. Pat. No. 4,314,525, U.S. Pat. No. 4,786,477, U.S. Pat. No. 4,784,840, U.S. Pat. No. 4,868,013, U.S. Pat. No. 4,992,245.

A third productive category consists in a purification method of melted silicon through liquid and gas treatment, as illustrated in patents JP2007084398, JP60103015, JP11011925, and further recovery methods of silicon from initial high-purity quartzite as discloses in the patent DE3128979F1.

A common feature of the majority of such known processes is the prediction of polycrystalline silicon manufacture from gaseous silicone compounds, for example by recovery methods or pyrolysis methods of silicious compounds pyrolytic in a core-type or boiling-bed reactor. Alternatively, such known processes foresee of refining of the starting silicious compounds, such as melted silicon treatment and high-purity quartzite recovery, avoiding formation of intermediate gaseous silicones formation.

Furthermore, very few multiple-stage technological processes are known, wherein both polycrystalline silicon and intermediate silicones used in its manufacture are produced within a continuous technological cycle from metallurgical silicon without the need of purchasing intermediate gaseous silicones from relevant manufacturers. For example it is known a process for the production of solar-grade polycrystalline silicon by means of silicon tetrafluoride SiF₄ decomposition in the inductively coupled argon-containing plasma. Such process involves the synthesis of silicon tetrafluoride through fluorinated gas feeding into the boiling bed of silicon pellets.

According to the Japanese patent JP2000178018, the production of polycrystalline silicon is based on a process comprising the reaction of metallurgical silicon with alcohol yielding trialkoxysilane; the trialkoxysilane disproportionation yielding monosilane; the thermal decomposition of monosilane in a boiling-bed reactor resulting in deposition of granulated silicon. The process involves recycling of gaseous reaction by-products and separation of high-purity quartz as one of the by-products. Similar technology is illustrated in the patent JP 2000178028.

Likewise, the patent RU 2 078 304 discloses a technological process for producing polycrystalline silicon by means of converting silicon tetrafluoride SiF₄ into dioxide and then into monoxide silicon which can be recovered with the help of hydrogen at high temperatures. In such case, silicon tetrafluoride is the result of silicofluoride Na₂SiF₆ thermal decomposition.

Instead, the U.S. Pat. No. 4,084,024 discloses a closed process for the production of polycrystalline silicon, wherein halogen-containing silicon compounds are first obtained through a reaction of metallurgical silicon with an halogen and hydrogen halide in a single cycle, following which the purified gaseous compound undergoes a thermal decomposition yielding high-purity polycrystalline silicon.

The patent RU2122971 discloses the production of polycrystalline silicon in a closed technological cycle involving trichlorosilane hydrogen reduction followed by hydrogen reduction and obtaining of polycrystalline silicon; the by-products of the gaseous mixture (SiCl₄, H₂, HCl) are separated and reused in producing trichlorosilane SiHCl₃, from metallurgical silicon.

The technology described in the U.S. Pat. No. 6,712,908 requires sequential steps of reacting metallurgical silicon with iodine yielding silicon tetraiodide followed by separation thereof from gaseous reaction by-products and deposition of silicon diiodide on the walls of the reactor providing polycrystalline silicon as a result.

The patent DE3311650 discloses the production of polycrystalline silicon from chlorosilane obtained from metallurgical silicon by means of reacting the latter with silicon tetrachloride and hydrogen with recycling of by-products for their reuse in production.

However, the above mentioned known solutions for producing polycrystalline silicon have significant disadvantages. Particularly, high energy consumption and low yielding of useful reaction products and the need for purchasing high-quality raw materials (high-purity metallurgical silicon) or siliceous gases for start-up production, are reported.

Another relevant drawback of the known solutions is the high production of wastes, difficult to be disposed from both an economic and environmental point of view.

### DISCLOSURE OF THE INVENTION

The scope of the present invention is to overcome the cited problems, with the provision of a process allowing to operate the production of polycrystalline silicon starting from metallurgical silicon in optimal mode, to be employed in particular in the production of photovoltaic solar panels production or analogues thereof.

In view of the aforementioned aim of the invention, it is a further object of the present invention to provide a process enabling the production of polycrystalline silicon with a reduced energy consumption.

A further scope of the present invention is to provide a process enabling the production of polycrystalline silicon with an high yield in comparison to inlet raw materials.

Another objective of the present invention is to provide a plant for the production of polycrystalline silicon according to the aforementioned process by a structure endowed with a greater structural and functional simplicity and reliable operating conditions.

According to the present invention the aforementioned objectives are achieved by the process of claim 1.

### BRIEF DESCRIPTION OF DRAWINGS

The details of the invention will result more apparent from the detailed description of a preferred embodiment of the process for the production of polycrystalline silicon starting from metallurgical silicon, illustrated in the enclosed FIGURE, wherein:

FIG. 1 shows a flowchart of the technological process for the production of polycrystalline silicon according to the process of the invention.

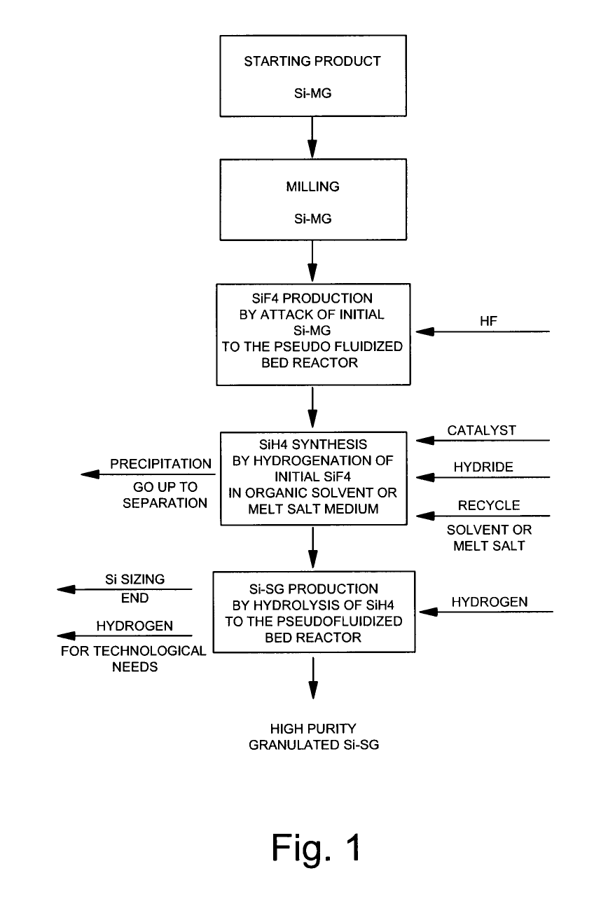

### EMBODIMENTS OF THE INVENTION

The process for the production of polycrystalline silicon starting from metallurgical silicon, milled up to a predetermined granulometry, including the steps of:

a. reacting metallurgical silicon with anhydrous hydrogen fluoride (HF), under the pressure of substantially 1.1 bar at a temperature ranging between 250-600° C., and preferably at 500° C., to obtain silicon tetrafluoride (SiF₄);
b. synthesis of monosilane (SiH₄) through a reaction of hydrogenation of silicon tetrafluoride (SiF₄) with alkaline or alkaline earth metals halide in fluid medium of organic solvent or melt salts;
c. carrying out the thermal decomposition of the monosilane (SiH₄) in a boiling-pseudo fluidized bed reactor, under a pressure of substantially 2 bar and at a temperature of substantially 650° C. to obtain high purity granulated polycrystalline silicon.

### Example 1

### Step a.

The process for the production of silicon tetrafluoride (SiF₄) is carried out by reacting metallurgical silicon with anhydrous hydrogen fluoride HF:

Si+4HF→SiF₄+2H₂

Preferably under a pressure of 1.1 bar and at a temperature comprised between the range 250-600° C.; the more effective temperature is about 500° C. The reaction is carried out in a boiling bed of metallurgical silicon pellets of 1 to 1.5 mm size, under a pressure not higher than 2 bar. The development of fluorocarbon gaseous compounds, like SiHF₃,SiH₂F₂, is significantly inhibited while carrying out the preceding reaction in maximum excess hydrogen fluoride from 0.1 to 1.1%. The silicon tetrafluoride SiF₄ undergoes purification in a recoverable absorber of HF traces and then is condensed in a low-temperature condenser-evaporator. The proceeding reaction is exothermic in nature (heat of reaction is 524.23 kJ/mole); thus heat supply from external heaters for material flow heating is only needed at the beginning of the process. Later on, the reaction heat is sufficient enough to maintaining the temperature of the reaction during the whole process. For excess heat removal from the reaction, the reactor contains extended surface heat-exchange elements.

The process for the production of silicon tetrafluoride SiF₄ comprises the following stages:
filling the reactor with the calculated amount of metallurgical silicon grains;
conversion of the silicon pellets bed into pseudo fluidized state with the help of an inert gas, at calculated rate sufficient for the pellets bed liquefaction such that not significantly exceeding necessary stoichiometric hydrogen fluoride consumption;
reaction gas synchronous feeding (HF) into the reactor with simultaneous reduction of the inert gas in the mixture. The process is carried out with excess of HF until the moment corresponding to the crushing of the starting metallurgical silicon pellets up to 0.1 to 0.2 mm of diameter. The output silicon tetrafluoride SiF₄ from the reactor is transferred for condensation and accumulates in a transitory condensing drum.

### Step b.

The monosilane synthesis from silicon tetrafluoride SiF₄ is carried out in lithium and potassium chlorides eutectic melt medium:

SiF₄+2CaH₂→SiH₄+2CaF₂

The above reaction is carried out in a bubbling reactor in ternary salt mixture ionic melt containing calcium hydride partly in the form of suspension and partly dissolved. Maximum pressure in reactor is 2.5 bar. The process temperature is conditional, on one side, on the salt mixture eutectic point, and on the other, on the necessity of preventing instant thermal decomposition of the monosilane directly produced in the reactor. Based on these considerations, the optimum process temperature range seems to be from 360 to 380° C.

The worked-out molten salt containing calcium fluoride undergoes recycling during which calcium fluoride CaF₂ is separated by means of filtration, and the salt mixture is returned into the process.

Monosilane is refined by using absorbing agent or filtered in order to remove mechanical particles after which it is compressed into a gas holder with the help of a diaphragm-type compressor.

Calcium fluoride in the form of feldspar is supplied to the manufacturer of HF to carry out the reaction:

CaF₂+H₂SO₄=2HF+CaSO₄

The process for the production of monosilane according to the present method comprises the following steps:
filling one of the chambers of a two-chamber bubbling reactor with the calculated amount of LiCl+KCl chlorides. The loading mass is calculated based on the assumption that calcium hydride solubility in the melt at the process temperature is 5%;
melting of chlorides mixture by means of resistance heating (the eutectic point of the melt is reached in reactor at the temperature range from 360 to 380° C.);
loading of calcium hydride CaH₂ to the shelf in the second chamber of the bubbling reactor, in the amount of 5% of the eutectic loading mass;
transferring the molten salt mixture into the second chamber of the reactor through an airlift pipe connecting the two chambers by means of creating differential pressure;
feeding silicon tetrafluoride through an airlift pipe into the molten salt mixture and reacting with calcium hydride dissolved or suspended in eutectic.

The process is accompanied by precipitation of insoluble calcium fluoride CaF₂. To separate it from the LiCl+KCl melt, a settling of precipitate is carried out within the calculated time and then calcium fluoride CaF₂ is removed with the help of one of the below methods:
molten salts are transferred into the first chamber of the reactor by means of creating inert gas differential pressure, while precipitated CaF₂, contained to some extent in the LiCl+KCl, mixture is discharged from reactor into a separate container and comes to a salt recycling installation for separation. The separated LiCl+KCl are delivered back to the reactor where monosilane synthesis is carried out;
LiCl+KCl melt and CaF₂, suspended therein are pumped from one side of the reactor to the other with the help of a centrifugal chemical pump. The pumped material passes through a micropore filter with the result that CaF₂ precipitate is separated. The obtained monosilane is subject to treatment with adsorbing agent and filtration in order to remove mechanical particles, and then it is compressed into a gas-holder with the help of a diaphragm-type compressor.

CaF₂ is used for the abovementioned purposes as derived y-product.

### Step c.

The process for the production of granulated polycrystalline by means of thermal decomposition of monosilane-containing reaction mixture in a boiling-bed reactor is carried out according to the reaction:

SiH₄→Si+2H₂

The process corresponding to the preceding reaction is carried out in a boiling bed of silicon pellets dispersed in a monosilane-hydrogenous mixture. Reactor shell is made of quartz; in order to avoid deposition of siliferous products on the heated walls, reactor heating is performed by means of infrared radiation. The optimum process temperature is 650° C.; pressure in the reactor is maintained at 2 bar. In order to inhibit development of silicon agglomerates in gaseous phase, the monosilane which is fed into the reactor is diluted with hydrogen. The hydrogen generated during the process is then purified, compressed up to 3 bar and delivered for reuse in the production process.

The process for the production of granulated polycrystalline foresees the following steps:
discharging the boiling-bed reactor of the calculated amount of silicon granules-seeds of about 0.125 mm in diameter;
pseudo fluidization of the silicon pellets bed by hydrogen flow at a flow rate not less than the minimum pseudo fluidizing rate;
feeding monosilane into the reactor with simultaneous reduction of hydrogen consumption, so that monosilane-hydrogen mixture with a monosilane content from 1 to 50% is fed. The process proceeds until the conventional finishing diameter of the pellets is reached. The time required to carry out the process can be determined based on the following equation:

$$\frac{d ( {d}_{\tilde{a} δ} )}{d t} = \frac{{w}_{{SiH}_{4}} \cdot {M}_{Si} \cdot π \cdot {d}_{0}}{3 π \cdot {ρ}_{Si} \cdot S \cdot H \cdot ( 1 - ɛ )}$$

where d_{ãδ} is current granule diameter, in mm; M_{Si} is molar weight of silicon, in g/mole; d₀ is starting granule diameter, in mm; S is bed diameter, in mm; H is bed height, in mm; ε is silicon pellets bed porosity; w_{SiH}_{₄} is kinetic constant of the chemical reaction, in s⁻¹.

When the calculated process time is elapsed according to equation, or the calculated finishing diameter of granules is reached, the process ends.

This process can also be carried out in a continuous reactor where constant withdrawal of produced polycrystalline silicon pellets and of core seeds is carried out.

For realization of the technological process in accordance with the described method, silicon seeds should be prepared for granulated polycrystalline silicon deposition, as well as starting silicon for etching in the course of SiF₄ production. For these purposes, two separate ball crushers are used.

### Example 2

The process for producing monosilane SiH₄ from silicon tetrafluoride SiF₄ is carried out according to the reaction:

SiF₄+4NaH→SiH₄+4NaF

The reaction is carried out in a bubbling reactor analogous to the one used in the preceding example. The reactive medium of the organic solvent may be tetrahydrofuran, diethylene glycol, or some ethers; it is preferred the use of zinc chloride. Other zinc-containing materials to be applied for catalysts are metallic zinc, zinc oxide, zinc alkylates with the general formula R₂Zn, wherein R is hydrogen radical with the general formula CₙH₂ₙ₊₁, as well as zinc hydride. It is preferable to use zinc catalyst in a finely ground form and usually it may be stirred in the course of reaction and introduced into the reaction vessel after ether and solid reagent.

In accordance with invention, in the course of the reaction process an automatic viscosity control of reaction medium in reactor is conducted and its value maintained constant by means of adding liquid organic solvent as viscosity increases.

Because of the exothermic nature of the reaction, temperature control is carried out by means of reaction vessel cooling through circulation of refrigerating medium which can be liquid nitrogen or recycle water. It is preferable to avoid boiling of the liquid reaction mixture because otherwise it will pass into cavitation regime deteriorating interphase gas-liquid contact. Even if the reaction proceeds at temperatures below 0° C., effective production rate can be achieved in short time. Therefore, when using tetrahydrofuran, it is preferable to carry out the process in a temperature range from 0 to 5° C. The more high-boiling ether is used the more is the advantage of the improved catalytic effect achieved at high temperatures, depending on the characteristics of the reaction medium. In any event, reaction temperatures in the range between 5 and 35° C. are the most effective. Such temperatures are preferable for convenience and simplicity of the operation.

The process is self-initiating and exothermic in nature. The amount of reagents used is at least stoichiometric estimating the required hydride amount on the basis of the defined degree of hydrogenation of silicon tetrafluoride. The amount of ether should be sufficient to keep the reaction mixture in liquid form. The amount of catalyst may be chosen from a broad range of values; nevertheless, the molar ratio catalyst:silicon tetraflouride is comprised the range from 1:10 to 15:1. More preferably the range is from 1:8 to 2:1, and in particular is 1:2. The contact of reagents takes place during mixing; it is advisable that sodium hydride milling should be carried out with an abrasive agent, such as sodium chloride added to the reaction mixture in order to obtain the effect on the metal hydride to obtain a live reaction surface.

The process for the production of monosilane according to the present reaction is carried out in a two-chamber bubbling reactor, similar to the one described previously. The technological steps carried out during monosilane production according to this process are:
filling the first chamber of the reactor with the calculated amount of a liquid organic compound acting as reaction medium;
filling the second chamber of the reactor with the calculated amount of sodium hydride 30 to 60% mass, depending on the organic compound selected;
transferring reactive organic compound into the second chamber of the reactor by means of inert gas differential pressure;
switching on the stirring device to obtain homogenous suspension of sodium hydride in the organic solvent volume;
feeding silicon tetrafluoride into the reaction medium through the airlift pipe and reacting with sodium hydride.

The process is accompanied by separation of sodium fluoride NaF precipitate. To separate it from organic solvent, the mixture of organic solvent and sodium fluoride is transferred into a recycling installation where centrifugal separation of solid precipitate takes place followed by organic solvent evaporization. The evaporated organic compound then enters a heat exchange installation where it liquates for possible reuse in the process.

In the monosilane synthesis process through the reaction of silicon tetrafluoride with calcium hydride, the calcium hydride used in the process is produced by calcium metal direct hydrogenation.

The reaction is carried out in a pseudo fluidized reactor through interaction of granulated calcium particles having a diameter from 1.5 to 5 mm, preferably at a temperature of 500° C. and under a pressure of 2.5 bar.

In accordance with the invention, recycling of unreacted hydrogen at the outlet of the reactor is contemplated for its reuse, after purification in different stages of the process cycle (calcium hydrogenation, monosilane thermal decomposition in a boiling-bed reactor).

The process for the production of calcium hydride contemplates the following operative steps:
filling the pseudo fluidized reactor with the calculated amount of granulated calcium;
feeding hydrogen at a flow rate not less than the minimum calcium granules pseudo fluidizing rate, and not significantly higher than stoichiometric hydrogen consumption for this reaction. The indicator of calcium and hydrogen reaction is pressure reduction of the hydrogen consumed in the reactor during the reaction. Whereas the sign of the end of the process is establishment of constant pressure in the reactor, which is a higher than the pressure observed during the process;
discharging calcium hydride pellets into a separate airtight container.

Wherein the technical features mentioned in each claims are followed by reference sign, such reference sign have been included for better understanding of the claims and therefore they are not limiting for the scope of each element identified by such reference sign.

1. A process for the production of polycrystalline silicon starting from metallurgical silicon, milled up to a predetermined granulometry, characterized in that it implies: a. reacting said metallurgical silicon with anhydrous hydrogen fluoride (HF), under a pressure of substantially 1.1 bar and at a temperature ranging between 250-600° C., to obtain silicon tetrafluoride (SiF₄); b. synthesis of monosilane (SiH₄) by a reaction of hydrogenation of said sili-con tetrafluoride (SiF₄) with alkaline or alkaline earth metals halide in fluid medium of organic solvent or melt salts; c. carrying out the thermal decomposition of said monosilane (SiH₄) in a boiling-pseudo fluidized bed reactor, under a pressure of substantially 2 bar and at a temperature of substantially 650° C., to obtain high purity granulated polycrystalline silicon.

2. A process according to claim 1, characterized in that it requires to react said metallurgical silicon with said fluoride-hydride (HF) at a temperature of substantially 500° C.

3. A process according to claim 1, characterized in that it requires to obtain said silicon tetrafluoride (SiF₄) with an excess of hydrogen fluoride in a mass percentage of 0.1-1.1%.

4. A process according to claim 1, characterized in that said alkaline metals hydride is constituted by sodium hydride (NaH).

5. A process according to claim 4, characterized in that it requires to carry out said hydrogenation reaction of said silicon tetrafluoride (SiF₄) with sodium hydride (NaH) at a temperature substantially of 0° C. in a liquid media of organic solvent such as tetrahydrofuran, diethylene glycol or simple ethers.

6. A process according to claim 1, characterized in that said alkaline-earth metal hydride is constituted by calcium hydride (CaH₂).

7. A process according to claim 6, characterized in that it requires to carry out said monosilane synthesis (SiH₄) by reaction of silicon tetrafluoride with calcium hydride (CaH₂) in the media of the eutectic melt of lithium chloride (LiCl) and potassium chloride (KCl) at a temperature ranging from 360° C. to 380° C. and under a pressure of substantially 2.5 bar.

8. A process according to claim 7, characterized in that it requires the use of calcium hydride (CaH₂) as hydrogen donator in said reaction with silicon tetrafluoride (SiF₄) by hydrogenation of the granular calcium with hydrogen in the pseudo fluidized-bed reactor at a temperature of substantially 500° C. and under a pressure of substantially 2.5 bar.

9. A process according to claim 1, characterized in that said thermal decomposition of said monosilane (SiH₄) is carried out in a pseudo fluidized bed of silicon pellets in a thermal decomposition reactor of said monosilane (SiH₄) quartz vessel, heated by radiation.

10. Plant for the production of polycrystalline silicon starting from metallurgical silicon, milled up to a predetermined granulometry, characterized in that it comprises means to produce the reaction of said metallurgical silicon with anhydrous hydrogen fluoride (HF), at a pression of substantially 1.1 bar and at temperature of 250-600° C., to obtain silicon tetrafluoride (SiF₄); means to carry out the synthesis of monosilane (SiH₄) by an hydrogenation reaction of said silicon tetrafluoride (SiF₄) with alkaline or alkaline earth metals halide in fluid medium of organic solvent or melt salts; means to op-erate the thermal decomposition of said monosilane (SiH₄) in a pseudo fluidized boiling bed reactor, at a pression of substantially 2 bar and at a temperature of substantially 65O° C., to obtain high purity granulated polycrystalline silicon.
